(19) United States
(12) Patent Application Publication
(10) Pub. No.: US 2017/0075308 A1
(43) Pub. Date: Mar. 16, 2017

(54) SINGLE PCB WRIST WORN DEVICE

(71) Applicant: KGPS (Israel) Ltd., Herzlia (IL)

(72) Inventors: Daniel IVESHA, London (GB); Gil MENDELSON, Tel-Aviv (IL); Allon GLADSTONE, Tel-Aviv (IL)

(21) Appl. No.: 15/122,957

(22) PCT Filed: Mar. 2, 2015
(86) PCT No.: PCT/IL2015/050224

§ 371 Date: Sep. 1, 2016

Related U.S. Application Data
(60) Provisional application No. 61/946,819, filed on Mar. 2, 2014.

(51) Int. Cl. G04B 47/06; G01S 19/16; G08B 21/02; G04B 37/14

(52) U.S. Cl. CPC G04B 47/06; G04B 37/1486; G01S 19/16; G08B 21/0269; G08B 21/0272

(57) ABSTRACT

A wrist worn device, comprising: a single piece flexible printed circuit board (PCB), the single piece flexible PCB having: a central portion fabricated with a central conducting area configured to connect electronically to an electronic source, a processing unit and a cellular communication circuit; a band portion fabricated with conductive materials for forming an integrated antenna electrically connected to the cellular communication circuit via the central conducting area; and a second band portion; a Global Positioning System (GPS) module electrically connected to the processing unit and to the electronic source via the central conducting area; a first band cover mounted to wrap the first band portion; a second band cover mounted to wrap the second band portion; and a central portion cover having a receptacle area for housing the electronic source, the processing unit and the cellular communication circuit.

### FIELD AND BACKGROUND OF THE INVENTION

The present invention, in some embodiments thereof, relates to a wrist worn device and, more particularly, but not exclusively, to a single printed circuit board (PCB) wrist worn device.

In today's increasingly mobile society, it is desirable to monitor the location and movement of humans, particularly children. Many children, especially young children, lack the understanding necessary to orient themselves and communicate sufficiently to find loved ones in the event that child become lost. Furthermore a lost child can easily become a victim to kidnapping or the clutches of a sexual predator.

Systems for tracking and monitoring individuals have been developed for several different applications. For example, individuals who have been convicted or released on bail, mentally ill patients or Alzheimer's patients that may become confused or disoriented or young children.

These systems usually include a location device such as a Global Positioning System (GPS) module and means of communication, such as a radio receiver or a cellular receiver.

### SUMMARY OF THE INVENTION

According to an aspect of some embodiments of the present invention there is provided a wrist worn device, comprising: a single piece flexible printed circuit board (PCB), the single piece flexible PCB having: a central portion fabricated with a central conducting area configured to connect electronically to an electronic source, a processing unit and a cellular communication circuit; a band portion fabricated with conductive materials for forming an integrated antenna electrically connected to the cellular communication circuit via the central conducting area; and a second band portion; a Global Positioning System (GPS) module electrically connected to the processing unit and to the electronic source via the central conducting area; a first band cover mounted to wrap the first band portion; a second band cover mounted to wrap the second band portion; and a central portion cover having a receptacle area for housing the electronic source, the processing unit and the cellular communication circuit.

Optionally, the single piece flexible PCB further having: a second band portion fabricated with a lateral conducting area configured to connect electrically to the GPS module and electrically connected to the processing unit and to the electronic source via the central conducting area.

More optionally, the second band cover is having a receptacle area for housing the GPS module.

Optionally, the wrist worn device further comprises a display mounted in the central portion.

Optionally, the wrist worn device further comprises a band tip conducting area configured to connect electrically to a wireless local area network (WLAN) module and electrically connected to the processing unit and to the electronic source.

Optionally, the wrist worn device further comprises a band tip conducting area configured to connect electrically to a Universal Serial Bus (USB) connector and electrically connected to the processing unit and to the electronic source.

Optionally, the USB connector includes an integrated WLAN module.

Optionally, the cellular communication circuit is used for identifying location of the wrist worn device 100 by using cell-tower triangulation.

Optionally, the single piece flexible PCB having a width of less than 0.2 millimeter (mm).

Optionally, the single piece flexible PCB comprises a plurality of layers, each layer having a width of less than 0.2 millimeter (mm).

Optionally, the GPS module and the cellular communication circuit are included in one combined unit.

Optionally, the wrist worn device further comprises at least one sensor for detecting a user gesture.

According to an aspect of some embodiments of the present invention there is provided a method of fabricating a wrist worn device, comprising: fabricating a single piece flexible printed circuit board (PCB), the single piece flexible PCB having: a central portion fabricated with a central conducting area configured to connect electronically to an electronic source, a processing unit and a cellular communication circuit; a first band portion fabricated with conductive materials for forming an integrated antenna electrically connected to the cellular communication circuit via the central conducting area; and a second band portion fabricated with a lateral conducting area configured to connect electrically to a Global Positioning System (GPS) module and electrically connected to the processing unit and to the electronic source via the central conducting area; wrapping the first band portion with a first band cover; wrapping the second band portion with a second band cover; and housing the electronic source, the processing unit and the cellular communication circuit in a receptacle area of a central portion cover.

Optionally, the method further comprises mounting a display in the central portion.

Optionally, the method further comprises attaching a band tip conducting area, the band tip conducting area is configured to connect electrically to a wireless local area network (WLAN) module and electrically connected to the processing unit and to the electronic source.

Optionally, the method further comprises attaching a band tip conducting area, the band tip conducting area is configured to connect electrically to a Universal Serial Bus (USB) connector and electrically connected to the processing unit and to the electronic source.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting. Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions.

Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of different views of a wrist worn device, according to some embodiments of the present invention;

FIG. 2 is a schematic illustration of a flexible printed circuit board (PCB), according to some embodiments of the present invention;

FIG. 3A and FIG. 3B are a schematic illustrations of different views of the flexible PCB of FIG. 2, mounted with electronic elements, according to some embodiments of the present invention;

FIG. 4 is a schematic illustration of an exemplary PCB including a band tip conducting area, according to some embodiments of the present invention; and

FIG. 5 is a flowchart schematically representing a method of fabricating the wrist worn device of FIG. 1, according to some embodiments of the present invention.

### DESCRIPTION OF EMBODIMENTS OF THE INVENTION

The present invention, in some embodiments thereof, relates to a wrist worn device and, more particularly, but not exclusively, to a single printed circuit board (PCB) wrist worn device.

Most location tracking wrist worn device, such as child device trackers, use “off-the-shelf” components, mostly due to time and cost constraints. Therefore, most child's location tracking watches have the same size as an adult-tracking watch.

According to some embodiments of the present invention, there is provided a location tracking wrist worn device, suitable for children, that includes a single flexible PCB and components which are directly built on and/or electrically connected to the flexible PCB.

The wrist worn device includes a single piece flexible PCB, optionally multilayered, printed with one or more antennas and connectors for other electronic elements. The wrist worn device further includes one or more cover elements which are mounted to wrap the flexible PCB and to form a flexible wrist worn device that does not apply redundant pressure on the wearer. The flexible PCB includes a central portion and two band portions. The central portion is fabricated with a central conducting area configured to connect electronically to an electronic source such as a battery, a processing unit, such as a microcontroller, a cellular communication circuit, and optionally motion sensors, such as accelerometers. One band portion is fabricated with conductive materials to form an integrated antenna for the cellular communication circuit, and the other band portion is fabricated with a lateral conducting area configured to connect electrically to a Global Positioning System (GPS) module. Optionally, one of the band portions includes in its tip a Universal Serial Bus (USB) connector. This USB connector may integrate a wireless communication unit, for example in parallel to (e.g. below) the pins array of the USB connector.

When used, the GPS module periodically identifies the location of the wrist worn device and periodically communicates with another device or a central server using the cellular communication circuit. Periodic GPS data acquisition patterns may be managed by the controller of the location tracking wrist worn device.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

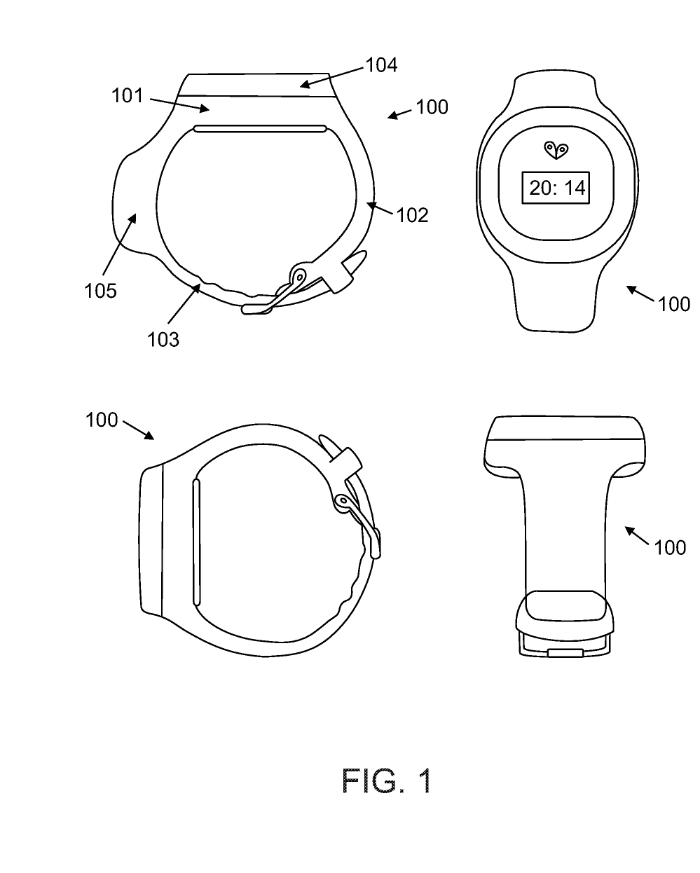

Referring now to the drawings, FIG. 1 is a schematic illustration of different views of a wrist worn device 100 made of a single piece of PCB having an integrated antenna and conducting areas for connecting a GPS unit, a battery and a cellular communication unit, according to some embodiments of the present invention.

The location tracking wrist worn device 100 includes a single piece flexible printed circuit board (PCB), optionally multilayered, printed with electronic components configured to mount electronic elements, and cover elements that wrap the PCB and the electronic components. The single piece flexible PCB has a central portion and band portion. The single piece flexible PCB electronically connects between electronic components and antenna(s) which are mounted on the band portions, and electronic components which are mounted on the central portion. By using the single piece flexible PCB, a location tracking wrist worn device may be assembled without an additional process of electronically connecting between band-supported electronic components and central portion electronic components. No hinges are required to connect bands areas, as the single piece flexible PCB also mechanically supports the connection of the band portions and the central portion and optionally the mounting of cover elements. This mechanical support is provided without reducing the flexibility coefficient in a manner that applies undue pressure on the wrist of the wearer.

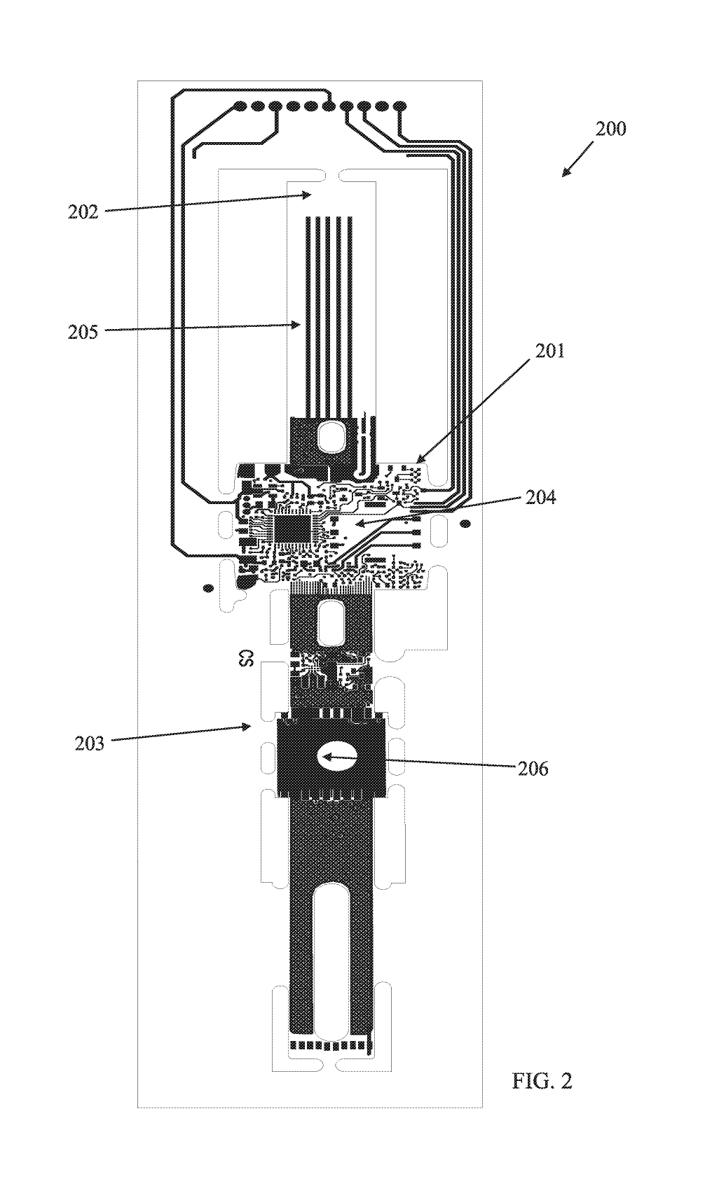

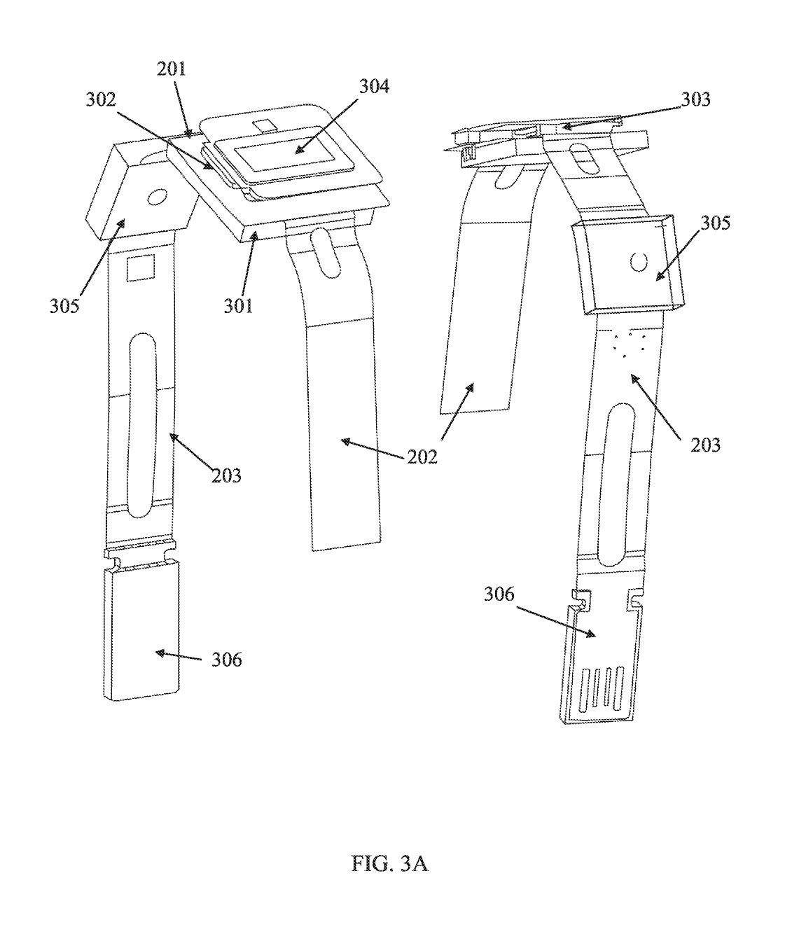

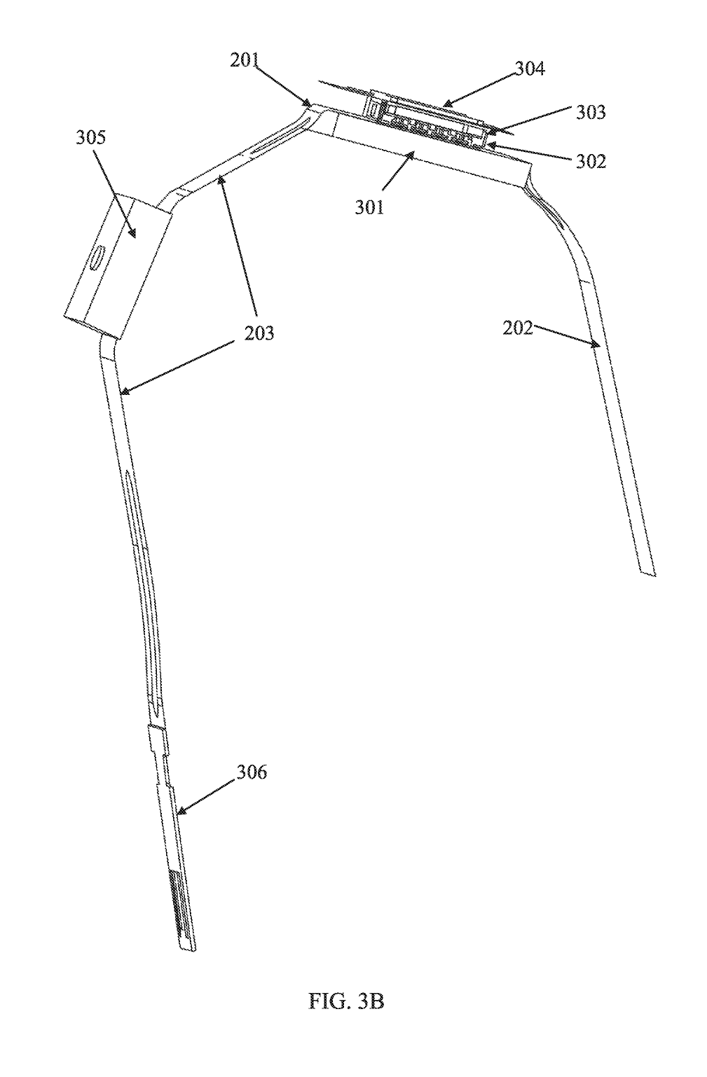

Reference is also made to FIG. 2, which is a schematic illustration of a flexible PCB 200 that is used for assembling a location tracking wrist worn device, such as 100, according to some embodiments of the present invention. Reference is also made to FIG. 3A and FIG. 3B, which are schematic illustrations of different views of the flexible PCB of FIG. 2, with electronic elements which are electrically connected to flexible PCB 200, according to some embodiments of the present invention.

Flexible PCB 200 may be any kind of thin board that may be printed with electronic circuits. Optionally, flexible PCB 200 has a width of less than 0.2 millimeter (mm), for example, a width of 0.18 mm or 0.19 mm. Optionally, flexible PCB 200 includes multiple layers, each layer having a width of less than 0.2 millimeter (mm), for instance 0.15 mm. Flexible PCB 200 may be, for example, of width 30 millimeter (mm) and of width 25 mm.

Flexible PCB 200 includes a central portion 201 fabricated with a central conducting area 204 configured to connect electronically to an electronic source 301, a processing unit 302 and a cellular communication circuit 303. Central portion 201 is wrapped with central portion cover 101. Central portion 201 may be, for example, of width 160 millimeter (mm) and of width 30 mm.

Electronic source 301 may be any kind of power source, such as Lithium polymer battery, Lithium-ion battery and/or any other kind of battery and/or a kinetic energy harvesting unit. Electronic source 301 powers all or some of the electronic components of location tracking wrist worn device 100 and should be sufficient for the operation of location tracking wrist worn device 100 for a prolonged period of time, such as a day, few days or more.

Processing unit 302 may include one or more processors, such as microprocessors. Processing unit 302 executes instructions for operating the components of location tracking wrist worn device 100 and/or for managing a display and/or for managing communication protocols between the electronic components or using the electronic components.

Cellular communication circuit 303 transmits the location of location tracking wrist worn device 100 to another remote device, such as a central system, a mobile phone of a parent, an email address and/or to a central server that distributes the data further to one or more guardians. Cellular communication circuit 303 may be, for example, a Global System for Mobile Communications (GSM) module for cellular communication, a code division multiple access (CDMA) radio transceiver device, a long term evolution (LTE) radio transceiver device, worldwide interoperability for microwave access (WiMAX) device, and/or other well-known interfaces for connecting to cellular network. Cellular communication circuit 303 may include a subscriber identification module (SIM) card, for example a small-form SIM such as micro-SIM, nano-SIM or embedded SIM which is permanently soldered to flexible PCB 200, further reducing the overall size of location tracking wrist worn device 100.

Optionally, cellular communication circuit 303 is also used for identifying location of location tracking wrist worn device 100 by using cell-tower triangulation, for example in areas where GPS coverage is problematic, such as indoors or near tall-buildings.

Optionally, central conducting area 204 is also configured to connect electronically to a wireless local area network (WLAN) module such as wireless fidelity (WiFi) module and/or a Bluetooth module. This may provide faster communication speeds and better indoor accuracy of location detection. The WLAN module is optionally integrated into the tip of the band portion, for example in parallel to the pin array of a USB connector 306 located at the tip of the band portion. This antenna allows establishing a wireless connection with the Internet or Intranet nodes identified by an Internet Protocol (IP) address, bridges and/or WLAN access points.

Optionally, central conducting area 204 is also configured to connect electronically to a display 304. Display 304 may be of any kind, mostly low-energy screens such as e-ink display or Electronic Paper Display (EPD) which requires small amount of electricity for display changed. Optionally, display 304 is very small, for instance with a length of around 2 centimeters (cm) and width of about 1 cm to further reduce power consumption and to fit on central conducting area 204.

Central portion cover 101 includes a receptacle area 104 for electronically connecting electronic source 210, processing unit 211 and cellular communication circuit 303 to the electronic components mounted on the bands and to an integrated antenna 205.

Flexible PCB 200 also includes an antenna band portion 202 fabricated with conductive materials for forming an integrated antenna 205 electrically connected to cellular communication circuit 303 via central conducting area 204. Antenna band portion 202 is wrapped with a band cover 102. Antenna band portion 202 may be, for example, of length 50 millimeter (mm) and of width 15 mm.

The Flexible PCB 200 made of a flexible substrate may provide second (or additional) dimension of array gain for the antenna, such as an end-fire antenna. The antenna(s) may allow communicating with base station controllers, such as radio network controllers, home location registers (HLR), visited location registers (VLR), Gateway GPRS Support Nodes (GGSN), Serving GPRS Support Nodes (SGSN), Serving Gateways (S-GW), and/or Packet Data Network Gateways (PDN-GW).

Integrated antenna 205 is used by cellular communication circuit 303 for transmitting and receiving data. The conductive materials may be, for example, copper, gold and/or any other material with electromagnetic conductivity properties. Flexible PCB 200 also includes a tracking band portion 203 fabricated with a lateral conducting area 206 configured to connect electrically to a Global Positioning System (GPS) module 305 and electrically connected to processing unit 302 and to electronic source 301 via central conducting area 204. Tracking band portion 203 is wrapped with a band cover 103. Optionally, band cover 103 includes a receptacle area 105 for housing GPS module 305. Tracking band portion 203 may be, for example, of length 80 millimeter (mm) and of width 10 mm.

Optionally, GPS module 305 is combined with cellular communication circuit 303 into one component, thus reducing the overall size of location tracking wrist worn device 100.

The location tracking wrist worn device 100 may also include an audio receptacle for receiving an audio jack. The audio jack may be associated with a speaker and/or microphone, such as an earphone or headset, for audio output or pickup. The audio receptacle may be connected via the central portion.

Central portion cover 101 and/or band covers 102 and 103 may be made of any non-conductive material, such as plastic, rubber, silicone, plastic, mylar, vinyl and/or any other material. The covers may physically separate from one another or portions of a single cast.

The cover may be cast onto flexible PCB 200 or may be manufactured separately and wrapped on flexible PCB 200.

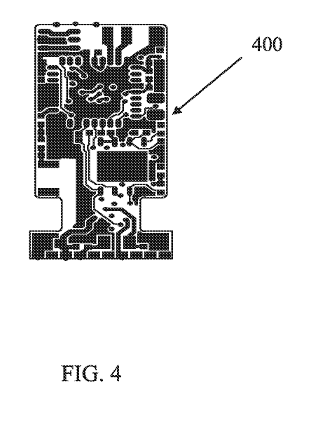

Reference is also made to FIG. 4, which is a schematic illustration of an exemplary PCB including a band tip conducting area 400, according to some embodiments of the present invention.

Optionally, location tracking wrist worn device 100 also includes a band tip conducting area 400 configured to connect electrically to a wireless module and electrically connected to processing unit 302 and to electronic source 210, for instance as outlined above.

The wireless module may include a WLAN module such as WiFi module and/or a Bluetooth module.

Band tip conducting area 400 may be printed on a separate PCB and may be connected at the edge of antenna band portion 202 or the edge of tracking band portion 203.

Optionally, location tracking wrist worn device 100 also includes a tamper alert sensor which identifies when the wristband of the location tracking wrist worn device 100 has been compromised or tampered with. The tamper alert sensor may be connected to or mounted on any part of flexible PCB 200.

The location tracking wrist worn device 100 can also include one or more sensors to detect a user gesture with the user's arm or wrist. For example, the movement sensors may include an accelerometer and/or gyroscope. Typically, the sensors are digital sensors. The gesture may correspond to specific movements of a user's wrist or arm and may vary with implementation. For example, the gesture might be a single shake (or bounce, tap, etc.) of the user's wrist for one user input option, and might be a pair of shakes for another user input option. Optionally, the movement sensor senses movement, direction of movement (up, down and sideways) and acceleration for monitoring wearer's behavior, such as moving rapidly, falls, impacts (crash), and also when there is no movement at all. The movement sensor may also be used to communicate a user-initiated alert, for example, when the user taps location tracking wrist worn device 100 with his other hand and then moves the wrist with location tracking wrist worn device 100 horizontally back-and-fourth 5 times, an alerts is triggered. Optionally, the monitoring and/or alert are transmitted via cellular communication circuit 303.

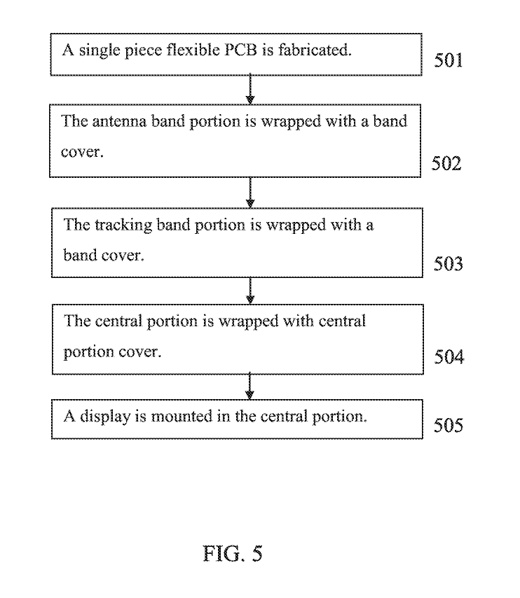

Reference is now made to FIG. 5, which is a flowchart schematically representing a method of fabricating the wrist worn location tracking wrist worn device 100 of FIG. 1, according to some embodiments of the present invention.

First, as shown at 501, single piece flexible PCB 200 is fabricated, having a central portion cover 101, an antenna band portion 202 and a tracking band portion 203.

Then, as shown at 502, antenna band portion 202 is wrapped with band cover 102.

Then, as shown at 503, tracking band portion 203 is wrapped with band cover 103.

Finally, as shown at 504, central portion 201 is wrapped with central portion cover 101, and electronic source 301, processing unit 302 and cellular communication circuit 303 are housed in a receptacle area.

Optionally, as shown at 505, a display is mounted in the central portion.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant PCB wrist worn device will be developed and the scope of the term wrist worn device is intended to include all such new technologies a priori.

The terms “comprises”, “comprising”, “includes”, “including”, “having” and their conjugates mean “including but not limited to”. This term encompasses the terms “consisting of” and “consisting essentially of”.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A wrist worn device, comprising:
a single piece flexible printed circuit board (PCB), said single piece flexible PCB having:
a central portion fabricated with a central conducting area configured to connect electronically to an electronic source, a processing unit and a cellular communication circuit;
a band portion fabricated with conductive materials for forming an integrated antenna electrically connected to said cellular communication circuit via said central conducting area; and
a second band portion;
a Global Positioning System (GPS) module electrically connected to said processing unit and to said electronic source via said central conducting area;
a first band cover mounted to wrap said first band portion;
a second band cover mounted to wrap said second band portion; and
a central portion cover having a receptacle area for housing said electronic source, said processing unit and said cellular communication circuit;
wherein said single piece flexible PCB having a width of less than 0.2 millimeter (mm).

2. The wrist worn device of claim 1, wherein said single piece flexible PCB further having:
a second band portion fabricated with a lateral conducting area configured to connect electrically to said GPS module and electrically connected to said processing unit and to said electronic source via said central conducting area.

3. The wrist worn device of claim 2, wherein said second band cover is having a receptacle area for housing said GPS module.

4. The wrist worn device of claim 1, further comprising a display mounted in said central portion.

5. The wrist worn device of claim 1, further comprising a band tip conducting area configured to connect electrically to a wireless local area network (WLAN) module and electrically connected to said processing unit and to said electronic source.

6. The wrist worn device of claim 1, further comprising a band tip conducting area configured to connect electrically to a Universal Serial Bus (USB) connector and electrically connected to said processing unit and to said electronic source.

7. The wrist worn device of claim 1, wherein said USB connector includes an integrated WLAN module.

8. The wrist worn device of claim 1, wherein said cellular communication circuit is used for identifying location of said wrist worn device 100 by using cell-tower triangulation.

9. (canceled)

10. The wrist worn device of claim 1, wherein said single piece flexible PCB comprises a plurality of layers, each layer having a width of less than 0.2 millimeter (mm).

11. The wrist worn device of claim 1, wherein said GPS module and said cellular communication circuit are included in one combined unit.

12. The wrist worn device of claim 1, further comprising at least one sensor for detecting a user gesture.

13. A method of fabricating a wrist worn device, comprising:
fabricating a single piece flexible printed circuit board (PCB), said single piece flexible PCB having:
a central portion fabricated with a central conducting area configured to connect electronically to an electronic source, a processing unit and a cellular communication circuit;
a first band portion fabricated with conductive materials for forming an integrated antenna electrically connected to said cellular communication circuit via said central conducting area; and
a second band portion fabricated with a lateral conducting area configured to connect electrically to a Global Positioning System (GPS) module and electrically connected to said processing unit and to said electronic source via said central conducting area;
wrapping said first band portion with a first band cover;
wrapping said second band portion with a second band cover; and
housing said electronic source, said processing unit and said cellular communication circuit in a receptacle area of a central portion cover;
wherein said single piece flexible PCB having a width of less than 0.2 millimeter (mm).

14. The method of claim 13, further comprising mounting a display in said central portion.

15. The method of claim 13, further comprising attaching a band tip conducting area, said band tip conducting area is configured to connect electrically to a wireless local area network (WLAN) module and electrically connected to said processing unit and to said electronic source.

16. The method of claim 13, further comprising attaching a band tip conducting area, said band tip conducting area is configured to connect electrically to a Universal Serial Bus (USB) connector and electrically connected to said processing unit and to said electronic source.
